(19) United States
(12) Patent Application Publication
(10) Pub. No.: US 2012/0084654 A1
(43) Pub. Date: Apr. 5, 2012

(54) Individualized Adaptable Media Presentations and Method

(75) Inventors: Jarom Lee, Salt Lake City, UT (US); William David Archer, Salt Lake City, UT (US); Ashkan Farhadtouski, Salt Lake City, UT (US); Chris Kluge, Riverton, UT (US)

(73) Assignee: LOLO, LLC, Salt Lake City, UT (US)

(21) Appl. No.: 13/251,012

(22) Filed: Sep. 30, 2011

Related U.S. Application Data
(60) Provisional application No. 61/388,559, filed on Sep. 30, 2010.

(51) Int. Cl. G06F 3/00

(52) U.S. Cl. 715/721

(57) ABSTRACT

Individualized, adaptable media presentations and a method for creating them are disclosed. In particular, each media presentation is generated according to user input and predetermined templates, overlaid with at least an instruction and an accompaniment layers generated from media clips (audio, video, audio/video) selected based on provided user data. The instruction and accompaniment layers are variable by the user and may then be overridden by the removal and replacement of individual media clips within the layer. The method and resultant media presentations as seen as ideal for exercise and physical training regimens, though may be utilized in any situation where recreation and instruction media presentation are used.

### CROSS-REFERENCES TO RELATED APPLICATIONS

This application claims priority as a non-provisional perfection of prior filed U.S. Provisional Application 61/388,559, filed Sep. 30, 2010 and incorporates the same by reference in its entirety herein.

### FIELD OF THE INVENTION

The present invention relates to the field of media content and more particularly relates to systems and methods for modifying media content in an individualized manner during playback of said media content.

### BACKGROUND OF THE INVENTION

People today have interests that can vary widely from one person to the next. Some people are interested in learning, others are interested in travel, and still others enjoy exercising. These types of activities can bring satisfaction to our lives. As a result, people often strive to improve in areas or activities they are familiar with as well as try new activities. One of the best ways to achieve good results in a given activity is to seek advice or suggestions from someone that is an expert in the relevant subject.

While there are many different subjects with experts, such as cooking, travel, general educational topics, etc., perhaps one of the most common subjects for which people seek those with expertise is physical fitness, including training, diet and exercise. The physical fitness industry is a multi-million dollar a year industry in the United States alone as people from all walks of life seek expertise to help with weight loss, physical conditioning and training for events. For the purposes of this Application, the field of exercise and fitness shall be used as a primary example of topic in the preferred embodiment of the invention. It is to be understood that the invention is adaptable to many different fields and topics and this specification should not be read so as to limit the invention to the field of exercise and fitness.

The experience and expertise of a subject matter expert can help us in a variety of ways. Subject matter experts, for example, often have the ability of being able to identify a preferred course of conduct or a preferred course of study. One of the attractions of personal trainers, and of fitness dubs in general, is their ability to motivate their users and to achieve better results than the individual can alone.

Unfortunately, seeking and obtaining the service of a subject matter expert can often prove difficult and expensive. For example, one wanting to achieve a fitness goal would probably seek a trainer, who is a subject matter expert for exercise or fitness. There are several reasons, however, that may prevent one from seeking the assistance of a personal training. For example, the cost of personal trainers, the current demand for personal trainers, scheduling conflicts, travel issues, and the like are examples of reasons why a particular user may not be able to find and benefit from the experience and expertise of a personal trainer. As a result, many individuals are left without the support and instruction needed to achieve desired fitness goals.

One attempt to fill this void can be found, for example, in DVDs, videocassettes, and the like. For example, people that want to exercise in their own homes can easily secure the necessary exercise equipment and can exercise to a workout DVD. Even though the DVD may have content that may have been prepared by a subject matter expert; it is difficult if not impossible to alter the content of the DVD. In other words, the DVD is typically mass produced and is not individualized for a particular user.

A DVD is often unable to dynamically adapt to the changing circumstances of a user. Thus, the needs of a particular user may be only partially satisfied, especially when the user advances past what the DVD has to offer. In other words, a DVD does not target specific individuals or the needs of specific individuals, but is typically targeted at a wide audience. The ability to bring the expertise of a subject matter expert in a dynamic way is lacking in existing technology and there is therefore a need to create instructions and personalized content in a portable medium to allow an individual to take a personalized media content with them in any location and for any subject.

Previous applications describe systems and methods for creating individualized media content from a media knowledge base. Individual selected media clips are stitched together to form a cohesive single media presentation. Clips may be selected by individual choice or by inputting data (“attributes”) into a program, which then matches stored media clips to inputted data and selects the clips on the user's behalf. While subject matter used in the parent applications may be any subject matter that tends itself to personal education, such as cooking, arts, languages, music, etc., the primary example has been exercise and physical fitness as this particular subject is of particular interest to a large number of people and the subject matter lends itself well to the technology.

The compiled media presentation had features similar to a DVD, that is to say that a user could fast-forward, repeat, or skip various component clips through the use of known marking, or “bookmarking” technologies. However, the presentation was static within itself. Once a presentation was created, it could not be changed. While a person might be able to skip some feature of the presentation, other aspects of the presentation, such as exercise intensity and duration, could not be altered. This lack of alteration limits the customization potential of the finished presentation and prevents modification. In the case of exercise, events that may cause a desire for modification could include the fact that a user may be “off” on a particular day, or may decide spontaneously to increase the intensity of a workout.

The present invention is a collection of systems and methods that create, not only media presentations that are tailored to a given user, but also are customizable during use to account for unforeseen circumstances and desires.

### SUMMARY OF THE INVENTION

In view of the foregoing disadvantages inherent in the known types of customized media presentations, this invention provides a customized adaptable media presentation. As such, the present invention's general purpose is to provide a new and improved media presentation that is seamlessly adaptable by a user.

To accomplish these objectives, the media presentations comprise separate instruction and accompaniment audio and/or video layers overlaid on a performance template. The template is generated from user input and is the base of instruction. The instruction and accompaniment layers in the form of media clips are variable within the template and allow a user to override the selected template, not only by allowing the user to skip or replay selected media clips, but also by overriding and replacing media clips in order to change individualized features, such as intensity, pace, type of music or any other such feature that the programmer desires to be customizable. The best mode is seen of particular use in exercise routines, but the method and resultant media presentation may be utilized in any situation where a media presentation may be used instructionally or recreationally.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a flowchart depicting a user interface for an individualized media presentation according to the present invention.

FIG. 2 is a flowchart depicting individual creation of an individualized media dip according to the present invention.

FIG. 3 illustrates an exemplary method for generating individualized media content from selectable components including selectable media dips;

FIG. 4 illustrates a general overview of a template used to construct the individualized media content;

FIG. 5 illustrates one embodiment of a template organization for an exercise routine;

FIG. 6 illustrates one embodiments of clips that have been selected and identified for inclusion in individualized media content; and

FIG. 7 illustrates an embodiment of a cadence outline that is included as part of a workout routine when the subject is exercise.

### DETAILED DESCRIPTION OF THE PREFERRED EMBODIMENT

With reference now to the drawings, the preferred embodiment of the individualized adaptable media content is herein described. It should be noted that the articles “a”, “an”, and “the”, as used in this specification, include plural referents unless the content clearly dictates otherwise. The method is depicted in a preferred embodiment of an exercise program with an audio accompaniment (“music”) track, however it is readily adapted to other instructional and recreational settings as well as being adapted by the use of different types of media clips and the depicted embodiment should not be seen as limiting.

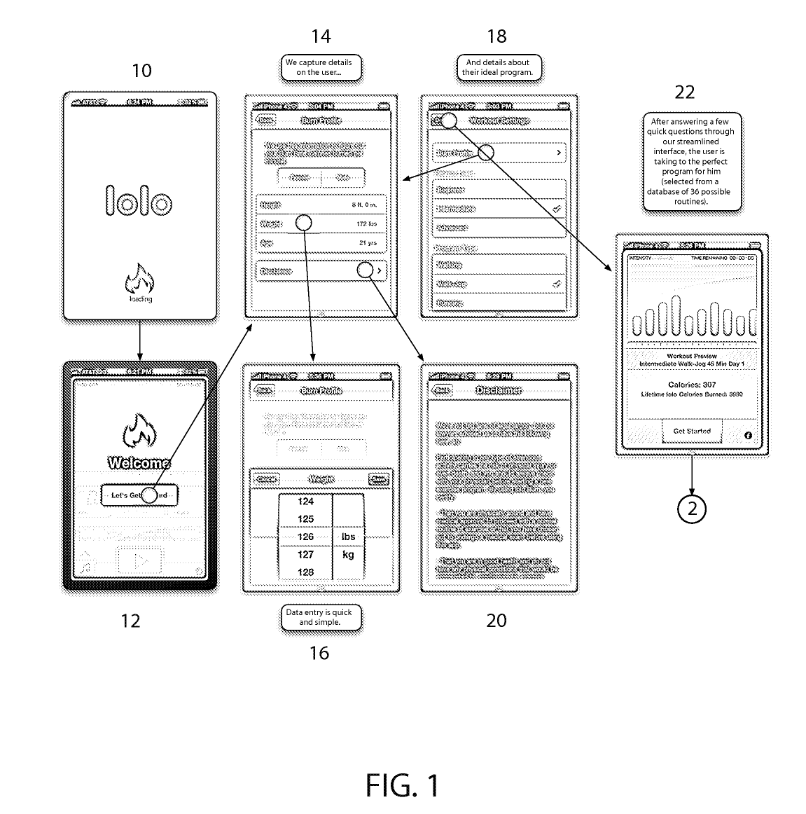

An example graphical user interface is shown in FIG. 1. As can be seen, the application, which serves as an expert system, loads 10 and prompts a user to enter data 12. The user data is entered and captured through a series of input screens 14, 16, 18. This data includes personal data, like weight, height, and physical condition 16. It also may include data input in desired goals and activities 18. A legal disclaimer screen 20 is provided for producer liability reasons and may be omitted or replaced with any other static data the producer wishes to broadcast to the user.

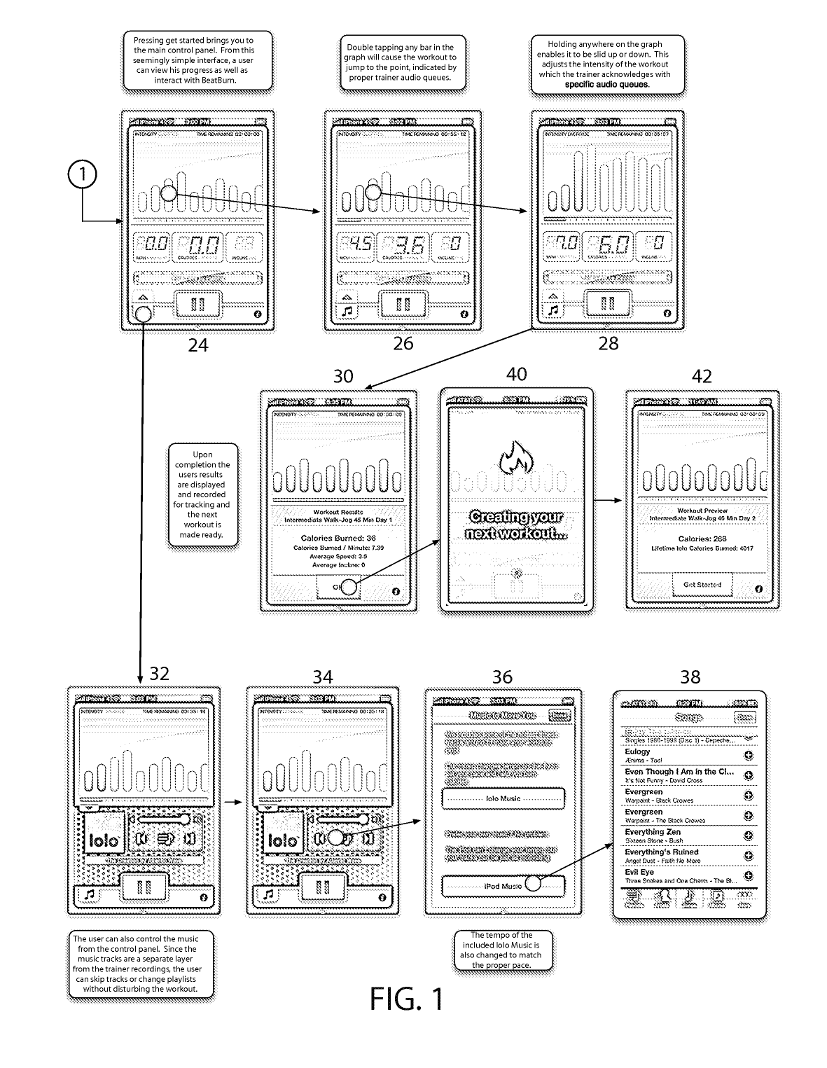

Once data is obtained, the application constructs the media program, shown in FIG. 2. The application accesses a database of media clip segments, in this case specifically instructional and accompaniment audio, video and audio/video tracks. These segments are assigned various values for activity, duration, intensity, desired cadence and any other quantifiable characteristic. Some media clips will be selected based on the user data, others are standard clips, such as exercise instruction videos, that are automatically used based on the selected activity. The media clips are then assembled together into a media program which features at least an instructional layer and an accompaniment layer using a provided template which also selected based on user data, 22. It should be noted that the instructional layer and the accompaniment layer (usually music) are independent of each other, though, ideally, both are controlled by the same user interface. It should also be noted that additional layers, such as a video layer, may also be added. It is important to realize that, even though media clips are assembled in to layers, the media clips remain discrete from each other—that is to say that the layers do not become an undivided whole. This then allows the individual clips to be replaced by another, usually related, clip as the user modifies the media presentation.

The graphical interface then allows the user to start the program 22 and make alterations thereto. Continuing the outline to sheet 2, in the depicted graphical interface 24, the entire program is depicted as a series of bars with each clip represented by a bar. Individual bars may be selected 26 to advance or reverse progress in the program. Likewise, individual bars may be adjusted 28 to increase or decrease intensity. In both cases, the action triggers an audio response in the instruction layer. In the event the program is advanced or reversed 26, the program merely jumps to that point in the program. In the event intensity is changed 28, the accompaniment layer is over-ridden and a new accompaniment track is selected and played. If the accompaniment track is music, a different song may be selected or the same song may be used but played at a higher or lower tempo. Likewise, the application adjusts the instruction layer to fit the new selection. The end result is a seamless transition to the new level. After the program has played, a final screen 30 is shown, detailing statistics from the session. These statistics may then be stores in a user profile, with inputted user data, for future use 40, 42.

The user may also utilize personal musical choices for the accompaniment layer 32. A simple button on the graphical user interface 34 may be used to communicate the override and open a selection screen 36 where the user can select the user's own stored music 38. It should be noted that, currently, personal music selections would not be adjusted to match intensity alteration as described above, but could be done in the future and still be under the purview of the present invention.

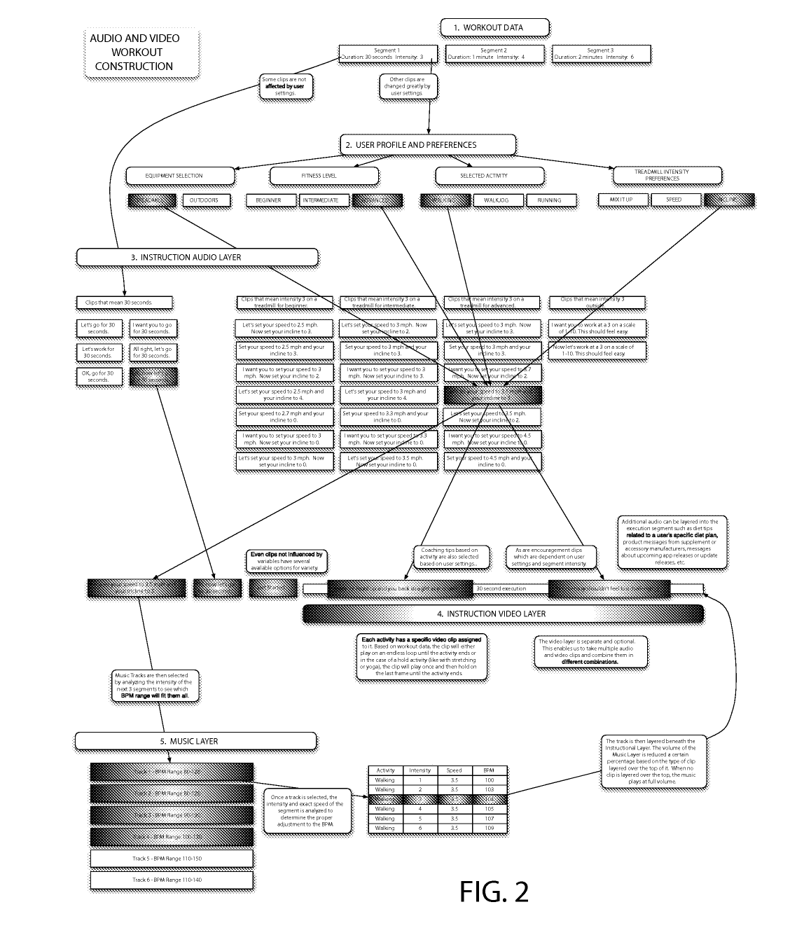

An example expert system and method utilized to construct media clips is depicted in FIGS. 3-7. FIG. 3 illustrates an exemplary flowchart from the perspective of a user that desires to receive individualized media content that, in the subject of exercise, may represent an individualized workout routine. If the subject of the knowledge base were educational, the individualized media content may represent a discussion of a particular topic and homework problems that are tailored to the user. With the benefit of this disclosure, one of skill in the art can appreciate that the individualized media content can be tailored according to the subject and is not limited to exercise.

The inputs typically provided are the user attributes 310. As previously stated, some of the user attributes are static (i.e., date of birth, age, medical history, etc.). Some of the user attributes are variable (age, weight, etc.). Some of the user attributes can also include the user's history. For example, a user may input the results of a previous workout routine, which may have an impact on the next workout routine generated by the expert system.

In this example, the user attributes 310 are provided to the expert system and/or have been previously entered. Using these attributes 310, the expert system queries the knowledge base to select methods 302 that match the user attributes 310. The result of the query is a subset of methods or a subset of data that may apply to the user or that may be included in the individualized media content.

Once the methods have been selected, the expert system executes rules 304 of the selected methods. The rules, in one embodiment, perform a distilling process on the selected methods. In one example, the rules are used to place specific methods (or IDs in one example, where each ID corresponds to a media clip) into a template or skeleton structure. The rules are the logic used to choose the specific methods from the subset of methods that match the user attributes.

For example, the expert system may return several methods for a particular part of the template. The rules may review the history of the user to identify methods that have already been performed such that methods are not repeated until all have been selected at least once. The rules may examine the methods for information provided by a subject matter expert to identify those methods that may be more relevant than other methods. The rules can perform ordering of the selected methods and associated media clips, filtering of the selected methods and associated media clips, and the like.

The resulting sequence of methods is then used to populate a workout table 306, which is one embodiment of a template. In one embodiment, the workout table 306 is populated with identifiers that each correspond to a media clip. Next, the individualized media content is generated 308 by mixing all of the media dips that are identified in the workout table to generate the individualized media content, which is the workout routine in this case. In some instances, the media content is mixed with background music and/or video to generate individualized media that can be delivered to the user. In one embodiment, the individualized media content is an mp3 file. The generation of the media content may be server and/or client based.

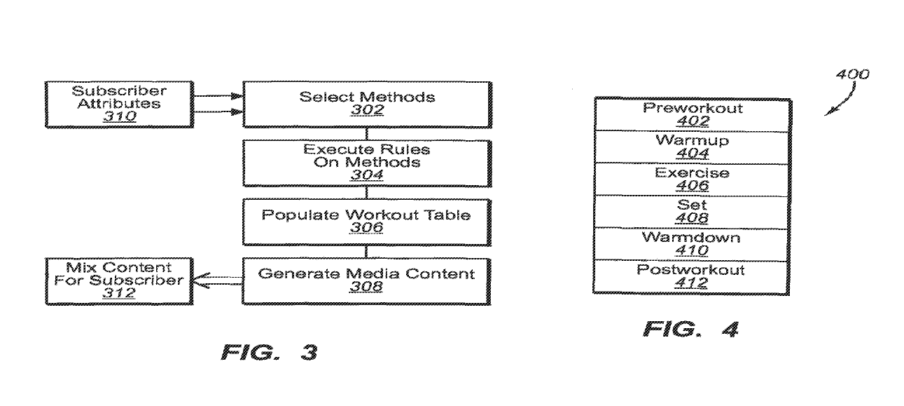

FIG. 4 illustrates one embodiment of an exercise template 400. The template 400 can be filled from content such as media clips from the knowledge base. In this example, the template 400 includes a pre-workout 402, a warm-up 404, an exercise 406, a set 408, a warm-down 410 and a postworkout 412. The selection of media clips to include in each part of the template 400 is performed by the expert system using the knowledge base as described above. Each portion of the template 400 may include more than one media cl that corresponds with one or more methods.

In another embodiment, a template can be populated with media clips that are determined as follows. The pre-workout 402 is populated by querying a trainer record, which includes a pre-workout media clip. The warm-up 404 is populated by querying a warm table (used for both warm-up and warm-down in one example) using a primary goal obtained from the user goal table.

The exercise 406 portion of the template 400 is populated by querying the attributes of the method table (and associated link tables), matching the attributes of the methods against the attributes of the user table to identify or obtain a list of appropriate exercises. Next, the trainer data is used to select the number and order of exercises from the identified methods. Applying the trainer data is an example of rules that are applied to selected methods. For each exercise, the appropriate media clip is obtained and inserted into the template or workout table.

The set 408 is obtained by querying a set table in the knowledge base using cadence and reps from the current exercise in order to obtain the appropriate counting media clip, which is then included in the set 408. The warm-down 410 is obtained by again querying the warm table using the primary goal obtained from the user goal table. Finally, the post-workout 412 is obtained by querying the trainer tables, which contain the post-workout media clip. Once the template or workout table is populated, it can be mixed and delivered to the user.

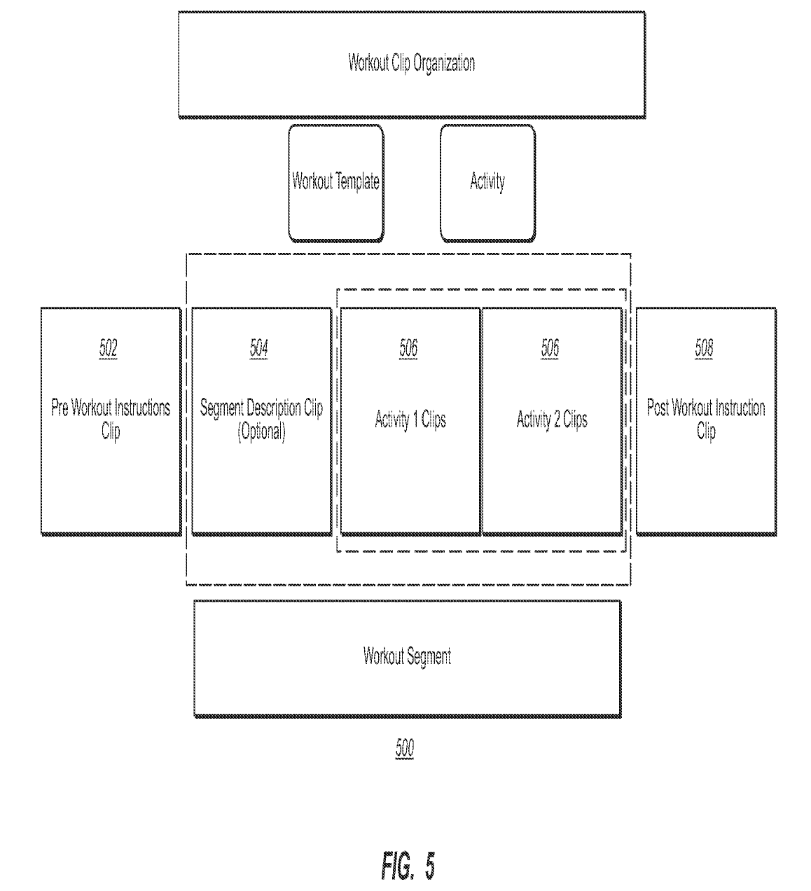

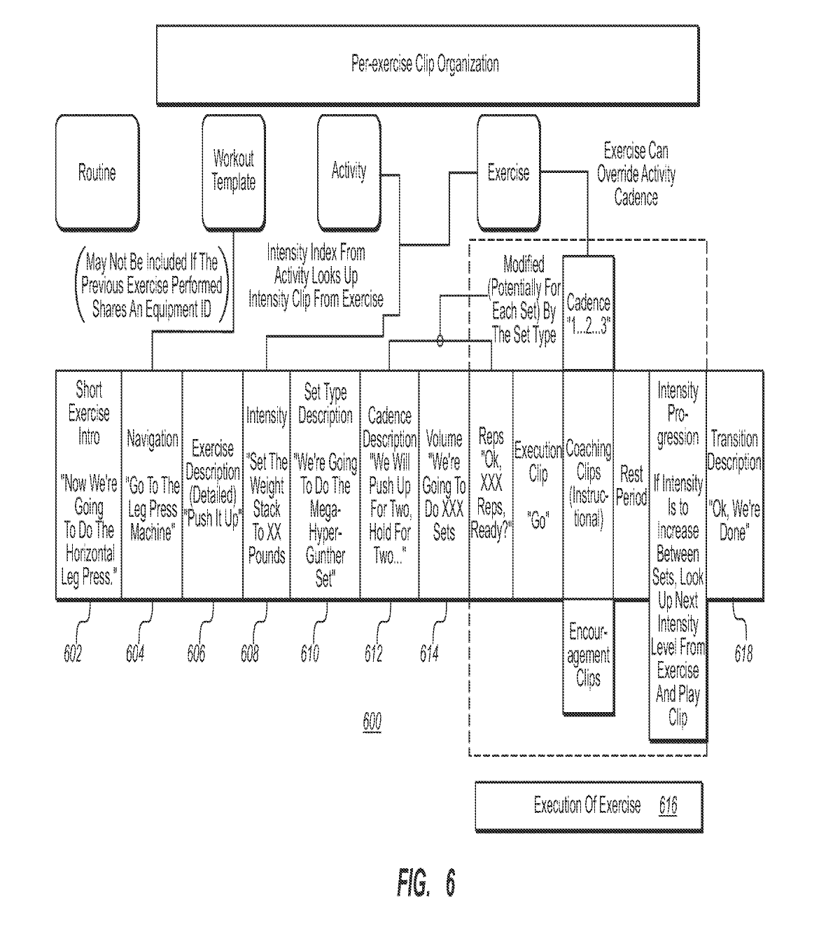

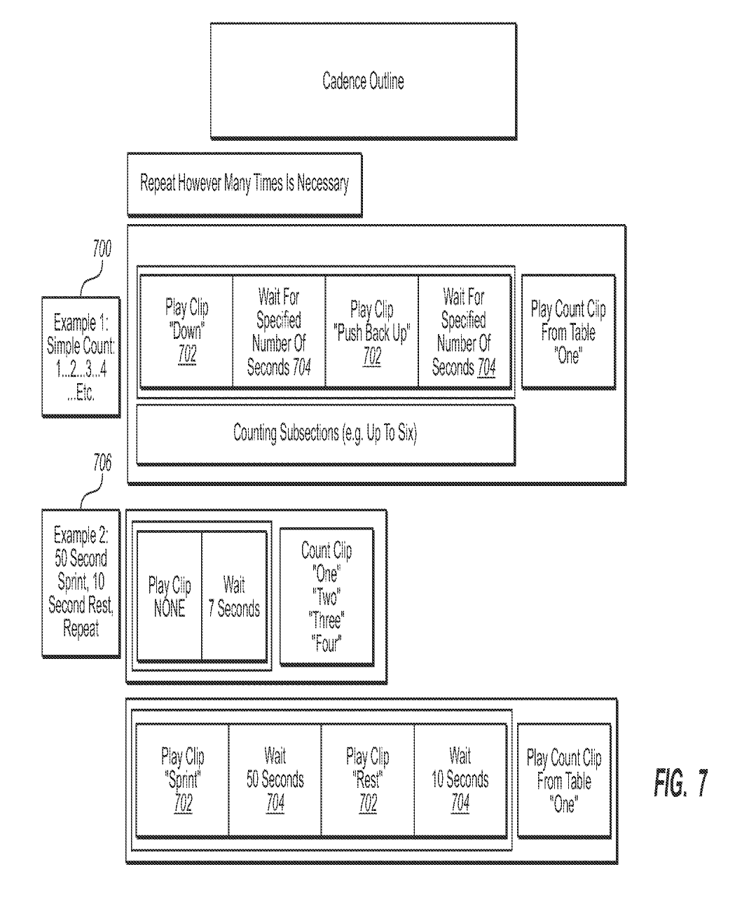

FIGS. 5, 6, and 7 provide additional details regarding the organization of the individualized media content generated for a user and in particular to systems and methods for creating media content with selectable components such as media clips. FIG. 5 is a broad overview of a workout clip 500. FIG. 6 is a more detailed view of the contents of an exercise portion of the workout clip 500 and FIG. 7 is a detailed view of cadence examples in the workout dip 500.

Further, FIGS. 5-7 illustrate that individualized media content can include many different clips that are ultimately mixed together to create an individualized media content. A user can have the ability to provide input that modifies the operation of the rules that distill matching data. For example, a user may indicate that only methods or data from a Page of particular trainer should be included in the media content. Alternatively, the user may specify that certain attributes have priority over other attributes.

With reference to FIG. 5, the workout dip 500 can be composed of various media dips (also referred to herein as scriptlets) selected by the expert system or by a logic module of the expert system as described above. FIG. 5, for example, illustrates that a complete workout clip 500 may contain pre-workout instruction media clips 502, segment description media clips 504, exercise (activity) media dips 506, post-workout media clips 508, and pause media clips (not shown, but can be inserted as needed), etc. Cadence media clips may be used to affect the difficulty, speed, repetition, etc., of a workout. The specific clips in the workout clip 500 can be selected by the application of rules to selected data or clips that match a user's attributes.

These media clips can be organized as discussed above, to include a pre-workout introduction warm-up, exercise, introduction, sets, warm down, and post workout conclusion. The workout clip can use the trainer-designed and user-matched workout templates and activities discussed above to select the individual media clips that match the user's goals and profile attributes. Other embodiments of the workout clip 500 can include fewer or more media clips. Alternatively, some of the clips or segments can be combined.

Referring to FIG. 6, the more detailed example of a per-exercise clip portion 600 of workout clip 200 is illustrated. Pre-exercise clips can be organized according to the template illustrated in FIG. 6 and the particular scriptlets or media clips can be selected based on the routines, workout templates, activity, and exercise data structures matched with the user's profile attributes and goals using the trainer methods. The user can also select a particular trainer, which can be an attribute of the user and used to match the user with particular clips or other data. The user can also be matched with the particular trainer based on the user's goals, health, available equipment, and/or any other attributes of the user. For example, where the user has a particular health issue the user can be matched with a particular trainer with goals and training philosophies tailored for the particular health issue of the user. Subsequently, the trainer's method, data, structures, and scriptlets can be matched to the user to create the individualized media program for the individual user.

As indicated in FIG. 6, an exercise portion 616 of the assembled per-exercise clip 600 may only comprise of a portion of the overall per-exercise clip 600. Other portions of the per-exercise clip 600 may be included as shown, such as introductions 602, navigations 604, exercise descriptions 606, intensity clips 608, descriptions of the set type 610, cadence description describing the pace 612, volume description 614, and transition descriptions 618. Thus, there can be clips that have been matched with the user that give detailed information and introduction to all aspects of the individualized workout for the user.

FIG. 7 illustrates a block diagram showing various clips making up two example cadence outlines. Example 1 (700) illustrates a simple cadence outline for a simple count type of exercise. As illustrated, the cadence clip can include various instruction clips 702 interposed with various pause 704 clips. The duration of the various instruction clips 702 and pause clips 704 can be dependent on any variable in the system. For example, the type of exercise, philosophies of the trainers, and attributes of the subjects can be matched with different instruction clips 702 and pause clips 704 to control the pace and timing of the exercise according to the cadence example clips shown in FIG. 7.

The cadence clips can include more detailed instructions tailored to any aspect of individualized media content. The cadence clips can include instructions that are tailored to the type of exercise, goals, user attributes, trainer, etc. Example 2 (706) illustrated in FIG. 7 shows a block diagram of a sprint-rest cadence clip for a particular exercise. As shown, the instruction clips 702 and pause clip 704 durations are tailored for the particular type of exercise and duration of activity that is conducted in response to the respective instruction according to this example.

Generally, the expert system organizes and arranges a list of media clips according to the information for each dip to create a complete workout clip, such as the clips illustrated in FIGS. 5-7, with the appropriate amount of scriptlets in the appropriate order according to the desired workout. As discussed above, the workout dip is associated with at least one of personal information, trainer information, exercise information, and general information to create a workout clip specifically personalized to the individual user.

The list of clips generated contains a list of identifying information for each clip necessary to produce the final workout clip (e.g., see FIG. 5). A media clip creation module uses the information from the list from the template to retrieve the appropriate clips or scriptlets from the appropriate modules and data bases storing the scriptlets, and combines, or mixes, the individual scriptlets according to the template to create a complete workout clip. Media clip creation module may also use media supplied by the user to mix a complete workout clip with background music selected by the user, further personalizing the media clip. Music may, however, be selected by any entity of the system, such as user, trainer, and knowledge engineer.

A workout clip may be stored on the user's computer, accessible by the user, and associated with a specific media organization program such as Apple, Inc.'s ITUNES, or other similar software, for download of music files to a personal media device such as an IPOD (also by Apple, Inc.), mp3 player, or other electronic device. A workout clip may then be played and utilized by the user to guide or assist with a workout. It should be appreciated that individualized video clips and combined video and audio clips of any format can also be assembled using the teachings set forth herein.

Although FIGS. 5-7 illustrate a workout routine, one of skill in the art can appreciate that the workout routine reflects the content or subject of the knowledge base. The process of generating the media content can be adapted to other subjects such that the resulting workout routing reflects the selected subject.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A method for providing a customizable media presentation, the method comprising:
a. Obtaining user data;
b. Selecting media clips based on user data;
c. Ordering media dips in a media presentation using a selected template;
d. Assembling the media dips into a media presentation based upon the template;
e. Providing individualized controls that may override the both order and the selection of the selected media clips within the media presentation; and
f. Playing the media presentation.

2. The method of providing a customizable media presentation of claim 1, the step of ordering media clips comprising ordering the media dips into at least one instruction layer and one accompaniment layer, each layer then being modifiable by the user by replacing individual clips within each layer.

3. The method of providing a customizable media presentation of claim 2, the individualized controls comprising a graphic interface and an individual control for every clip, such that a dip within the media presentation may be selected and replaced with another, related, clip by activating the control for that clip.

4. The method of providing a customizable media presentation of claim 3, the media clips being selected from a set of media clips consisting of: audio clips, audio clips and audio/video clips.

5. The method of providing a customizable media presentation of claim 4, each clip being assigned attributes and the step of selecting media clips comprises comparing user data to the attributes of the media clips and, through a logic program, selecting the media clips thereby.

6. The method of providing a customizable media presentation of claim 1, the individualized controls comprising a graphic interface and an individual control for every clip, such that a clip within the media presentation may be selected and replaced with another, related, dip by activating the control for that clip.

7. The method of providing a customizable media presentation of claim 6, the media dips being selected from a set of media dips consisting of: audio dips, audio clips and audio/video clips.

8. The method of providing a customizable media presentation of claim 7, each dip being assigned attributes and the step of selecting media clips comprises comparing user data to the attributes of the media clips and, through a logic program, selecting the media dips thereby.

9. The method of providing a customizable media presentation of claim 1, the media dips being selected from a set of media dips consisting of: audio dips, audio clips and audio/video clips.

10. The method of providing a customizable media presentation of claim 9, each dip being assigned attributes and the step of selecting media clips comprises comparing user data to the attributes of the media clips and, through a logic program, selecting the media dips thereby.

11. A customizable media presentation generated by the method of claim 1.

12. A customizable media presentation generated by the method of claim 2.

13. A customizable media presentation generated by the method of claim 3.

14. A customizable media presentation generated by the method of claim 4.

15. A customizable media presentation generated by the method of claim 5.

16. A customizable media presentation generated by the method of claim 6.

17. A customizable media presentation generated by the method of claim 7.

18. A customizable media presentation generated by the method of claim 8.

19. A customizable media presentation generated by the method of claim 9.

20. A customizable media presentation generated by the method of claim 10.
